(19) United States
(12) Patent Application Publication
(10) Pub. No.: US 2017/0188102 A1
(43) Pub. Date: Jun. 29, 2017

(54) METHOD AND ELECTRONIC DEVICE FOR VIDEO CONTENT RECOMMENDATION

(71) Applicants: Le Holdings (Beijing) Co., Ltd., Beijing (CN); LE SHI INTERNET INFORMATION & TECHNOLOGY CORP. BEIJING, Beijing (CN)

(72) Inventor: Yuwei ZHANG, Beijing (CN)

(21) Appl. No.: 15/250,629

(22) Filed: Aug. 29, 2016

Related U.S. Application Data
(63) Continuation of application No. PCT/CN2016/089055, filed on Jul. 7, 2016.

(30) Foreign Application Priority Data
Dec. 23, 2015 (CN) 201510980566.X

(51) Int. Cl. H04N 21/466; G06F 17/18; H04N 21/442; H04N 21/25; H04N 21/258; H04N 21/45; G06N 7/00; G06F 17/16

(52) U.S. Cl. CPC H04N 21/4662; G06N 7/005; G06F 17/18; G06F 17/16; H04N 21/251; H04N 21/25891; H04N 21/4532; H04N 21/4668; H04N 21/44222

(57) ABSTRACT

A method and an electronic device for video content recommendation are disclosed. The electronic device for video content recommendation analyzes user historical view data to obtain various personalized preference parameters; sorts and crosses user historical view data according to various personalized preference parameters and user individual characteristic information, to obtain group view data that is in accordance with personalized preference parameters and user individual characteristic information; processes group view data according to an independent variable matrix that represents historical view data, an independent variable matrix that represents user individual characteristic information, and a dependent variable matrix that represents group view data; based on a result of the processing, uses a channel corresponding to each video content as an independent variable, to obtain a corresponding coefficient; performs conversion according to a given ratio, to obtain a recommendation weighting coefficient Wi; and recommends corresponding video content according to different weighting coefficients Wi.

### CROSS REFERENCE TO RELATED APPLICATIONS

This present disclosure is a continuation of International Application No. PCT/CN2016/089055, filed on Jul. 7, 2016, which is based upon and claims priority to Chinese Patent Application No. 201510980566.X, filed on Dec. 23, 2015, the entire contents of which are incorporated herein by reference.

### TECHNICAL FIELD

The disclosure relates to the field of video technologies, and more particularly, to a method and an electronic device for video content recommendation.

### BACKGROUND

In recent years, enterprises specialized in the Internet, network video, IT, household appliances and even consumer electronics start to expand into the conventional broadcasting and television field one after another in many crossover manners (for example, cross-screen, cross-platform, cross-network, and cross-ecological chain).

As these enterprises continuously encroach on both the user group and market share of conventional broadcasting and television institutions, the conventional broadcasting and television institutions finally realize that the crisis has arrived. Leading broadcasting and television institutions in some regions start to keep a close watch on new technical trends and new technologies all over the globe, and also want to take be opportunity to launch an effort in fields such as cloud computing, big data, cloud storage, 3D, and holographic imaging.

With the rapid development of the Internet, especially social networks, we are now in an information overload age. Faced with excessive information, users can hardly find content that they are really interested in, and content providers also find it difficult to accurately push high-quality content to users who are interested in such content. A push system is considered as an effective method to solve these problems. The push system mines historical behaviors of users, sets up a model for interests of the users, and predicts future behaviors of the users, thus establishing a relationship between the users and content.

Video websites are also confronted with the information overload problem. For example, YouTube has billions of video items at present, and videos with duration of nearly 1500 minutes are uploaded every minute; the professional video website Hulu also has nearly 200,000 high-quality videos, and it is also difficult for users to find content that they are really interested in from these videos. Besides, it is also very important to improve watch and dwell duration of users. Therefore, a recommendation system is necessary for video websites.

Current video websites are mainly classified into two types, where one type is websites dominated by User Generated Content (UGC websites), for example, the foreign website YouTube and the domestic websites. Youku and Tudou; the other type is websites dominated by professional video content, for example, the foreign websites Hulu and Netflix, and the domestic websites iQIYI, sina video, and tv. sohu. com. To draw attention from advertisers and the capital market, the domestic UGC video websites, such as Youku and Tudou, also transform one after another to become websites that combine both UGC and professional video content. Content and user behaviors of the two types of video websites are different, leading to certain differences in design of corresponding recommendation systems.

Comparatively speaking, the UGC website has a large quantity of videos and relatively rich content; however, the quality of content varies a lot, most videos are short ones, and no desirable content data is available. Generally, a recommendation is made based on individual videos, and videos are filtered according to video quality (for example, repeated videos are removed and the minimum number of views is limited). UGC content has a relatively short life cycle, and therefore, the design of the recommendation system emphasizes the timeliness, and latest videos are recommended to users, to keep the recommendation fresh. Besides, the UGC website provides a wide variety of content and users generally do not have strong purposes, and therefore, the recommendation needs to be diversified and correlated to latest behaviors of users as much as possible.

Content in a professional video website generally has good structured content data, and videos are basically organized based on television dramas or films. Therefore, a recommendation is generally made based on episodes rather than individual videos. Episodes are further classified into on-air shows and library shows depending on whether they are being played at the time being. Comparatively speaking, an on-air show is more popular, and users have many channels to learn about the on-air show and have a clear Catch-up demand for the on-air show, while previous episodes are more suitable to be recommended. Generally, videos have relatively long duration and episodes include a lot of videos; acceptance costs for users are relatively high, and recommendation timing is also an issue that the professional video a website needs to consider. For example, at weekends or in holidays, users are relatively free and there are generally no on-air shows, and it is suitable to recommend some long dramas and the like.

Nevertheless, except for these differences, it is generally considered that the design. of recommendation systems for video websites need to follow some basic principles, for example, the system can provide reasonable recommendations to earn the trust of users; the system can response in time to behaviors of users; recommendation logic is transparent to users; users are encouraged at an appropriate time to participate and feed back information actively; and a recommendation result needs to provide sufficient information.

In terms of recommendation product forms, recommendations currently used in video websites include the following categories: related recommendation, personalized recommendation, personalized television channel, and the like.

The related recommendation is to recommend, to a user, videos related to a video currently being watched or browsed by the user, that is, “users like this video may also like,” and a result presents important information of a video (title, thumbnail, average score, genre, year, duration, brief introduction, director, actor/actress and the like), and provides a score option or “not-interested” option to collect user feedback.

The personalized recommendation is to infer interests of a user according to all historical behaviors of the user, and accordingly recommend a list of videos that the user is most probably interested in. Compared with the related recommendation, the personalized recommendation comprehensively uses all historical behaviors of the user, including scoring, viewing, subscription, searching, tagging, sharing, commenting, and the like, rather than a single browsing or viewing behavior at present, and therefore, reflects interests of the user more accurately. The historical behaviors may reflect diversified user interests, and therefore, clustering is generally performed in a personalized recommendation result according to relatively independent points of interest (for example, genre). For example, a personalized recommendation is presented in the following form: clustering is performed on a result according to genres of recommended videos, and a user can switch genres that the user is interested in; the result includes very detailed video content information and the most useful user comment information; the recommendation result is explained; the user can directly provide a feedback of “already watched” or “interested or not” with respect to the recommendation result, and if the user is interested in the recommendation result, the user may further specifically add the recommendation result to favorites or directly go to the watch page.

Users may create their own channels, or the recommendation system automatically creates a video program channel that meets interests of a user according to historical behavior of the user. The user may watch videos in the channel incessantly, and during playback, the system continuously collects feedback (like, dislike, skip, finish watching) for videos from the user and adjusts the recommendation list in real time, so that the user sees an increasingly satisfying result.

A personalized recommendation system has a promising development and application prospect. At present, almost all large e-commerce systems such as Amazon and eBay have used various forms of recommendation systems to different extent. Domestically, well-known shopping sites such as Mbaobao, VANCL, coo8.com, redbaby all take the lead to choose a percentage point recommendation system, which is the most advanced locally; to construct a personalized recommendation service system. In an increasingly fierce competition environment, the personalized recommendation system can effectively retain customers, and improve the service capability of the e-commerce system. A successful recommendation system brings great benefits. On the other hand, various Web sites providing personalized services also need powerful support from recommendation systems. The domestic leading recommendation system BAIFENDIAN.COM also contributes to the personalized content recommendation of Web sites, and in this information explosion era, it is imperative to implement personalized reading.

It is generally considered that methods of recommendation systems can be classified according, to two dimensions: data and model. In terms of used data, recommendation systems can be classified into a collaborative filtering system, a content filtering system, a social filtering system, and the like; in terms of used models, recommendation systems can be classified into a neighborhood-based model, a matrix decomposition model, a graph model, and the like.

Collaborative filtering is the most well-known method among recommendation. systems, and it mainly makes recommendations for users by analyzing historical behaviors of the users to obtain interests of the users. The collaborative filtering has many algorithms, where neighborhood algorithms (User CF, Item CF, and the like), matrix decomposition algorithms (or Latent Factor Model, such as RSVD and SVD++), graph algorithms, and the like are common collaborative filtering algorithms. Current, a collaborative filtering algorithm commonly used in video websites is Item CF, of which the basic assumption is that a user likes videos similar to those the user likes before. Therefore, when recommendations are made for the user, first of all, a list of videos that the user likes needs to be obtained from historical behaviors of the user, and then videos most similar to the list that the user likes before are found from remaining videos and are recommended to the user. As can be seen, the core of this method is how to rationally calculate the similarity between two videos, where a cosine similarity, a Pearson correlation coefficient, or the like is commonly used, and revisions need to be made according to a specific situation during practical use. Generally, it is considered that the Item CF algorithm is relatively simple, is easy to extend, has relatively high accuracy, can be updated in real time and explained, and can process explicit feedback (scoring or being interested in) or implicit feedback (other behaviors such as watching). Therefore, the Item CF algorithm is used in actual video recommendation systems such as Netflix, Hulu, and YouTube. One important disadvantage of the collaborative filtering method is that it does not support cold start, that is, a newly added video cannot be recommended and no recommendation can be made for a new user; generally, the collaborative filtering method needs to be used together with other recommendation methods (such as content filtering) to solve this problem.

The basic idea of content filtering is to recommend, to users, other videos having content similar to videos the users like before. For example, if a user likes Lock, Stock and Two Smoking Barrels, the content filtering system recommends other works with similar content of Guy Ritchie, for example. Snatch; if a user likes Naruto, the system recommends Naruto Shippuden or other exciting Japanese animations. Therefore, the core of content filtering is how to calculate a content similarity between two videos. In general cases, the content similarity between videos is calculated in the following manner: extracting keywords from content of a video (for example, title, genre, region, production company, year, director, actor/actress, synopsis, user tag, and comments), then determining weights of these keywords to obtain a vector model of this video, and then calculating a similarity between vector models of two videos. With the great success of the expert tagging system Pandora in the field of music recommendation, similar websites also appear in the video field, for example, Jinni, which defines more than 900 tags (genre, plot, class, year, location, mood, suitable group for watching the film, favorable comments, style, attitude, image, and the like) for describing film genes, and then film experts add these tags to each film, so as to obtain a vector space of expert tags of each film and make recommendations on the basis of the vector space. Expert tagging is extremely labor-consuming and does not have a recognized benefit, and therefore is not used on a large scale in practice. General video websites still use a relatively conventional method in which content filtering is performed with reference to video content and user tags.

The idea of social filtering is that the preference of a user may be influenced by friends of the user on a social network. With the booming of SNS networks, the social network recommendation draws more attention. For example, the video search website Clicker makes recommendations by using a friend relationship on Facebook; of course, another benefit of using Facebook is that the video website can obtain more information of users, especially, some Like information outside the website, and this also helps improve the recommendation quality.

A main task of a video recommendation system is to analyze historical behaviors of a user to obtain interests of the user, then find videos that meet the interests of the user, and present the found videos to the user. Therefore, a complete recommendation system includes at least a log system, a recommendation engine, a presentation interface design, and the like.

The log system mainly collects behaviors of users and feedback for the recommendation system from the users. The recommendation engine is also divided into two parts: an offline part and an online part: an offline system is mainly responsible for generating a video correlation matrix and storing the matrix in a database, for real-time query and invoking by an online system; and the online system is responsible for responding to requests of users in real time, extracting and analyzing user behaviors online, and generating a final recommendation result.

The offline part of the recommendation engine calculates a series of correlation matrices (for example, the similarity between every two videos, and the correlation between a film theme and a video) by using collected user behavior logs; and calculates feedback (such as a weight of a user behavior and a weight of a recommendation algorithm) of all users or some user groups for the recommendation system.

During video content recommendation, content to be recommended needs to be found from massive videos with duration of tens of thousands of hours; investment of labor and time required traditionally is beyond imagination and is also impractical. Therefore, how to search for a particular target from massive videos and recommend the target to a user has become an urgent problem that needs to be solved in current video content recommendation.

Various manual screening methods for video content recommendation at present cannot implement refined video content recommendation specific to different channels.

### SUMMARY

The present disclosure provide a method and an electronic device for video content recommendation, to solve the defect it the related art that a user cannot perform refined video content recommendation specific to different channels.

An aspect of the present disclosure provides a method for video content recommendation including: at an electronic device; analyzing user historical view data to obtain various personalized preference parameters; sorting and crossing the user historical view data according to the various personalized preference parameters and user individual characteristic information, to obtain group view data that is in accordance'with the personalized preference parameters and the user individual characteristic information; processing the group view data according to an independent variable matrix that represents the historical view data, an independent variable matrix that represents the user individual characteristic information, and a dependent variable matrix that represents the group view data; based on a result of the processing, using a channel corresponding to each video content as an independent variable, to obtain a corresponding coefficient; using the channel as an independent variable according to a given ratio, to obtain a corresponding recommendation weighting coefficient Wi converted from the coefficient; and recommending corresponding video content according to different weighting coefficients Wi.

An embodiment of the present disclosure provides an electronic device for video content recommendation, including: at least one processor and a memory communicably connected with the at least one processor for storing instructions executable by the at least one processor, wherein

execution of the instructions by the at least one processor causes the at least one processor to:

analyze the user historical view data to obtain various personalized preference parameters; sort and cross the user historical view data according to the various personalized preference parameters and user individual characteristic information, to obtain group view data that is in accordance with the personalized preference parameters and the s r individual characteristic information; process the group view data according to an independent variable matrix that represents the historical view data, an independent variable matrix that represents the user individual characteristic information, and a dependent variable matrix that represents the group view data; based on a result of the processing, use a channel corresponding to each video content as an independent variable, to obtain a corresponding coefficient;

use the channel as an independent variable according to a given ratio, to obtain a corresponding recommendation weighting coefficient Wi converted from the coefficient; and determine corresponding recommended video content according to different weighting coefficients Wi; and the transmitter is configured to send the recommended video content.

An embodiment of the present disclosure provides a non-transitory computer-readable storage medium storing executable instructions that, when executed by an electronic device with a touch-sensitive display, cause the electronic device to:

analyze user historical view data to obtain various personalized preference parameters;

sort and cross the user historical view data according to the various personalized preference parameters and user individual characteristic information, to obtain group view data that is in accordance with the personalized preference parameters and the user individual characteristic information; and process the group view data according to an independent variable matrix that represents the historical view data, an independent variable matrix that represents the user individual characteristic information, and a dependent variable matrix that represents the group view data;

based on a result of the processing, use a channel corresponding to each video content as an independent variable, to obtain a corresponding coefficient;

use the channel as an independent variable according to a given ratio, to obtain a corresponding recommendation weighting coefficient Wi converted from the coefficient; and

recommend corresponding video content according to different weighting coefficients Wi.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural diagram illustrating a digital cable television and broadcasting system according to an embodiment of the present disclosure;

FIG. 2 is a schematic structural diagram illustrating a UMTS communications system according to another embodiment of the present disclosure;

FIG. 3 is a schematic structural diagram illustrating a video content recommendation device according to another embodiment of the present disclosure; and

FIG. 4 is a schematic flow chart illustrating a method for video content recommendation according to another embodiment of the present disclosure.

### DETAILED DESCRIPTION

To make the objectives, technical solutions and advantages of the embodiments of the present disclosure clearer, the technical solutions in the embodiments of the present disclosure are described clearly and completely with reference to the accompanying drawings in the embodiments of the present disclosure. Apparently, the described embodiments are merely some of rather than all of the embodiments of the present disclosure. Based on the embodiments of the present disclosure, all other embodiments derived by a person of ordinary skill in the art without any creative efforts shall fall within the protection scope of the present disclosure.

The video content recommendation method and device described herein may be configured as various television systems such as a cable television system, a video website, and as e-commerce website.

The video content recommendation method and device described herein may be implemented by using various terminals, such as a computer, a television set, and a wireless terminal having a video playback system.

The wireless terminal having a video playback system may refer to a device that provides audio and data connectivity for users, a handheld device that has a wireless connection function, or another device connected to a wireless modern. The wireless terminal having a video playback system may communicate with one or more core networks through a wireless access network (for example, RAN which is short for Radio Access Network); the wireless terminal having a video playback system may be a mobile terminal such as a mobile phone, and a computer having a mobile terminal, for example, a portable, pocked-sized, handheld, computer built-in or vehicle-mounted mobile apparatus having a video playback system, which exchange voice and/or data with a radio access network. For example, the wireless terminal may be a device such as a Personal Communication Service (PCS) telephone, a cordless telephone, a Session Initiation Protocol (SIP) telephone, a Wireless Local Loop (WLL) station, and a personal digital assistant (PDA). The wireless terminal having a video playback system may also be referred to as a system, a subscriber unit, a subscriber station, a mobile station, a mobile, a remote station, an access point, a remote terminal, an access terminal, a user terminal, a user agent, a user device, or a user equipment

In addition, the terms “system” and “network” herein are often used interchangeably. The term “and/or” is merely an association relationship for describing associated objects, which represents that there may exist three types of relationships, for example, A and/or B may represent three situations: only A exists, both A and B exist, and only B exists. In addition, the character “/” herein generally represents an “or” relationship between associated objects before and after the character.

The video content recommendation device according to the embodiments of the present disclosure is a video content providing device or a video content providing server, the illustrated video content providing device or video content providing server provides video content for a user terminal through a digital cable television and broadcasting system or a wireless network communications system and the user terminal may be a computer, a PDA, a television set, a mobile phone television, a vehicle-mounted mobile television, or the like.

Analog television has three standards: NTSC, PAL, and SECAM. At present, digital television has three different digital television standards in the US, Europe, and Japan respectively. The standard in the US is the Advanced. Television System Committee (ATSC) standard; the standard in Europe is the Digital Video Broadcasting (DVB) standard; and the standard in Japan is the Integrated Services Digital Broadcasting (ISDB) standard. Related standards are also formulated in China: the China Mobile Multimedia. Broadcasting (CMMB) standard and the Digital Multimedia Broadcasting (DMB) standard. A DVB transmission system involves all transmission media such as satellite, cable television, terrestrial, SMATV, and MMDS. DVB standards corresponding thereto are: Digital Video Broadcasting-Satellite (DVB-S) standard, Digital Video Broadcasting-Cable (DVB-C) standard, and Digital Video Broadcasting-Terrestrial (DVB-T) standard.

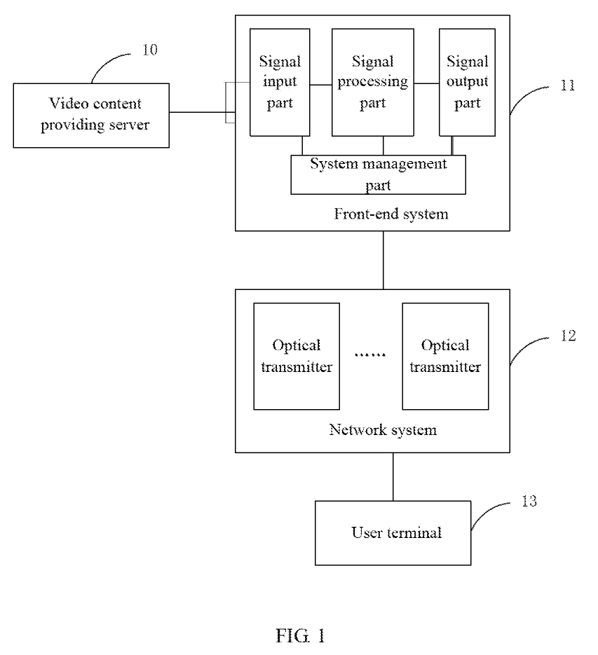

For example, FIG. 1 is a schematic structural diagram illustrating a digital cable television and broadcasting system according to an embodiment of the present disclosure. The digital cable television and broadcasting system includes a video content providing server 10, a front-end system 11, a network system 12, and a user terminal 13, where the video content providing server 10 is configured to provide video content, the front-end system 11 is the core of the whole digital cable television system, the network system 12 is a foundation platform of the system, and the user terminal 13 implements a final result.

The front-end system 11 is an information source and an exchange center of a cable television network, and generally consists of devices such as a digital satellite receiver, a video server, a codec, a multiplexer, a QAM modulator, various management servers, and a control network part. The cable television front-end system 11 generally can be divided into four major parts: a signal input part, a signal processing part, a signal output part, and a system management part, where each part has a particular function, thus finally forming the complete cable television front-end system.

The input part receives many programs from different networks, for example, in various access manners such as satellite and open loop reception, and some signals are formed after local analog television programs are subject to coding compression and pass through a video server; the received signals are converted into signals of a uniform format and sent to the signal processing part.

The signal processing part includes: descrambling, multiplexing, SI processing, and the like, and is the core of a digital front end. The signal processing part mainly completes processing such as descrambling, interception, and multiplexing than all programs. Service information is kept updated, to ensure that a set top box is guided correctly to operate normally, and that all application data can be correctly inserted. In addition, the signal processing part needs to be managed by using an integrated management system, and the Asynchronous Serial Interface (ASI) is used as a standard interface at all front-end processing parts. In this way, devices provided by any vendor can be added easily, achieving desirable compatibility.

The signal output part receives information that has been processed by the signal processing part, converts the information into a signal having a format required by the transmission network, where a typical 64 QAM modulator is used in the cable television network. During use of the modulator, the setting and debugging of an output level and frequency are extremely important.

Various management servers of the system management part mainly complete some user information management and billing work, and management work as well as security and secrecy of film and television materials. The control network part mainly completes transfer work of various information in various servers, and exchange of background film and television materials and data.

The network part 12 includes various optical transmitters that generally faun the following topology structures: a star structure, a tree structure, a star-tree mixed structure, and a dual-star structure with cascading of two stages of optical links.

The user terminal 13 may consist of a digital set top box (SIB) and a display, or consist of a network terminal and a display, and uses the cable television network as a transmission platform, to allow users to enjoy comprehensive information services such as cable television and data broadcasting.

The video content providing device or video content providing server can be combined with not only the digital cable television and broadcasting system but also various communications systems, and is configured to provide comprehensive information services such as cable television and data broadcasting for users.

Various communications system include, for example, current 2G and 3G communications systems and next generation communications systems, such as a Global System for Mobile communication (GSM), a Code Division Multiple Access (CDMA) system, a Time Division Multiple Access (TDMA) system, a Wideband Code Division Multiple Access Wireless (WCDMA) system, a Frequency Division Multiple Access (TDMA) system, an Orthogonal Frequency-Division Multiple Access (OFDMA) system, a General Packet Radio Service (GPRS) system, a Universal Mobile Telecommunications (UMTS) system, a Long Term Evolution (LTE) system, and other communications systems of this type.

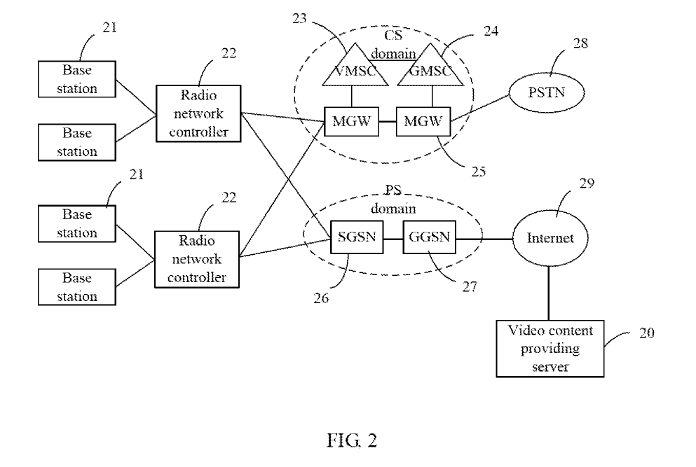

For example, by using a UMTS network as an example, FIG. 2 is a schematic structural diagram illustrating a UMTS communications system according to another embodiment of the present disclosure. The UNITS communications system includes an access network and a core network in communication with each other, where the access network includes multiple base stations 21 and multiple radio network controllers 22; the core network is divided into a circuit-switched domain (CS domain) and a packet-switched domain (PS domain); the CS domain mainly includes voice services and consists of a Mobile Switching Center (MSC) server and a Media Gateway (MGW) that are connected to each other, where the MSC server includes a Visited Mobile-services Switching Centre (VMSC) 23 and a Gateway Mobile Switching Center (GMSC) 24 that are connected to each other. The PS domain mainly includes mobile data services, and mainly consists of a Serving GPRS Support Node (SGSN) 26 and a Gateway GPRS Support Node (GGSN) 27 that are connected to each other. The MGW 25 is further connected to a Public Switched Telephone Network (PSTN) 28, and the like. The GGSN 27 is connected to a video content providing server 20 through the Internet 29.

The video content providing server 20 is configured to provide video content, and provide video content for a user terminal through the UNITS communications system.

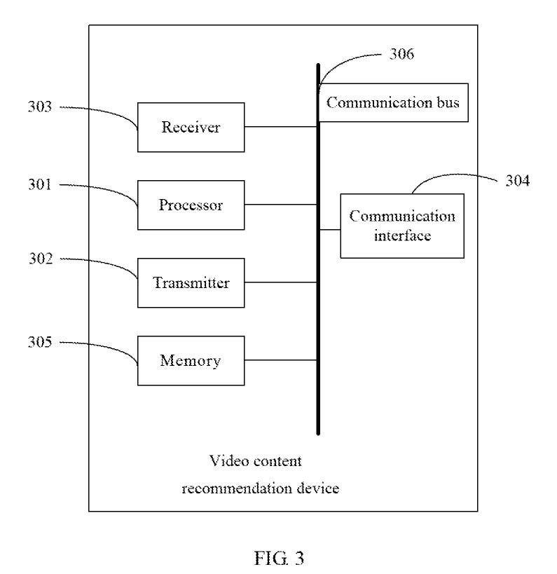

The video content providing servers 10 and 20 have a same structure, and the video content providing servers 10 and 20 may also be used as a video content recommendation device. For example, FIG. 3 is a schematic structural diagram illustrating a video content providing device according to another embodiment of the present disclosure, and a specific structure and a specific working process thereof are as follows:

The video content recommendation device includes a processor 301, a transmitter 302, a receiver 303, a communication interface 304, a memory 305 and a communication bus 306, where the processor 301, the transmitter 302, the receiver 303, the communication interface 304 and memory 305 complete mutual communication through the communication bus 306.

The processor 301 may be a central processing unit (CPU) or an Application Specific Integrated Circuit (ASIC), or configured as one or more integrated circuits for implementing the embodiments of the present disclosure.

The memory 305 is configured to store program code, where the program code includes a computer operation instruction. The memory 305 may include a high-speed RAM memory, or may also include a non-volatile memory, for example, at least one magnetic disk memory.

The communication interface 304 is configured to implement connection and communication between these apparatuses.

The receiver 303 is configured to receive user view data.

The processor 301 is configured to execute the program code, and configured to analyze user historical vie data to obtain various personalized preference parameters; sort and cross the user historical view data according to the various personalized preference parameters and user individual characteristic information, to obtain group view data that is in accordance with the personalized preference parameters and the user individual characteristic information; process the group view data according to an independent variable matrix that represents the historical view data, an independent variable matrix that represents the user individual characteristic information, and a dependent variable matrix that represents the group view data; based on a result of the processing, use a channel corresponding to each video content as an independent variable, to obtain a corresponding coefficient; use the channel as an independent variable according to a given ratio, to obtain a corresponding recommendation weighting coefficient Wi converted from the coefficient; and determine corresponding recommended video content according to different weighting coefficients Wi.

The transmitter 302 is configured to send the recommended video content.

The processor 301 being configured to process the group view data according to an independent variable matrix that represents the historical view data, an independent variable matrix that represents the user individual characteristic information, and a dependent variable matrix that represents the group view data specifically includes: the processor 301 being configured to put the independent variable matrix that represents the historical view data, the independent variable matrix that represents the user individual characteristic information, and the dependent variable matrix that represents the group view data into a mixed effect model formula (1), and perform an operation on the group view data according to the mixed effect model formula (1).

In another embodiment of the present disclosure, a sum of all sequences of the weighting coefficient Wi is 100%.

The mixed effect model, mixed model for short, is also known as a mixed variance component model or a variance analysis model III, which includes both a fixed effect model and a random effect statistical model.

The fixed effect is similar to a standard regression coefficient, and is directly estimated by means of regression on historical data.

The random effect is not directly estimated (although it may be obtained through estimation afterwards), but is concluded from variance and covariance estimated values of the historical data. The random effect is presented in a form of a random intercept or a random coefficient, and a data organization structure may include multiple levels haying groups nested therein. In this way, the mixed effect model is also referred to as a multilevel model and a hierarchical model in literature. A mixed effect command for fitting of a mixed effect model that reflects distribution variations is set on the condition of a random effect conforming to a normal distribution.

The complexity and comprehensiveness of the mixed effect model can effectively capture a stable characteristic (fixed effect) and a characteristic that varies randomly (random effect) of data.

The processor 301 performs a data operation by using the following mixed effect model formula (1).

Yᵢ=Xᵢβ+Zᵢbᵢ+εᵢ formula (1)

Xᵢ=ZᵢKᵢ is a known (nᵢ×p) covariance matrix. Any related parameter is defined according to an actual condition. β represents the fixed effect, bᵢ represents the random effect, where β and bᵢ are corresponding coefficients obtained by using a channel as an independent variable; Yᵢ represents a dependent variable matrix, and represents the group view data, fix example, a group of videos that a certain user has watched (where the group needs to be refined to videos of different type attributes); Xᵢ represents an independent variable matrix, and represents the user individual characteristic information, for example, user individual characteristic information (such as age, gender, and income) of a user; εᵢ represents a built-in error term matrix that is generated by the mixed effect model, and does not need to be defined manually; Zᵢ represents another series of independent variable matrices whose attribute is different frown that of Xᵢ, for example, the user historical view data; Kᵢ represents a weighting coefficient, which satisfies Xᵢ=ZᵢKᵢ after a series of settings in advance; nᵢ represents the i^{th} sample among n samples; p represents a parameter reflected by an actual matrix operation result, and does not need to be defined manually; i represents a sequence number i in the i^{th} sample, and is a positive integer: i=1, 2, 3, . . . , i.

The mixed effect model formula (1) further needs to satisfy the following requirements:

bᵢ˜N(0,D)

εᵢ˜N(0,Σᵢ)

cov(b₁,b₂, . . . , bᵢ;ε₁,ε₂, . . . ,ε_{N})=0

Wherein bᵢ˜N(0,D) represents that b conforms to a standard normal distribution, and N (0, D) represents the standard normal distribution.

εᵢ˜N(0,Σᵢ) represents that ε conforms to a standard normal distribution, εᵢ˜N(0,Σᵢ) represents the corresponding standard normal distribution, and Σᵢ represents a sum operation.

cov(b₁,b₂, . . . , bᵢ;ε₁,ε₂, . . . ,ε_{N})=0 represents a covariance matrix, and coy represents a covariance.

In another aspect of the present disclosure, a density equation of the dependent variable Yi is further used as a reference for a model result of the mixed effect model formula (1), where the density equation is defined as formula (2):

f(yᵢ)=∫f(yᵢ|bᵢ)f(bᵢ)dbᵢ formula (2)

wherein f(yᵢ) represents an expression symbol of the density equation, yᵢ represents an element in the dependent variable Yi, f(yᵢ|bᵢ) represents a density equation of f (y) expressed with b, f(bᵢ) represents a density equation of b, and d represents a differential symbol.

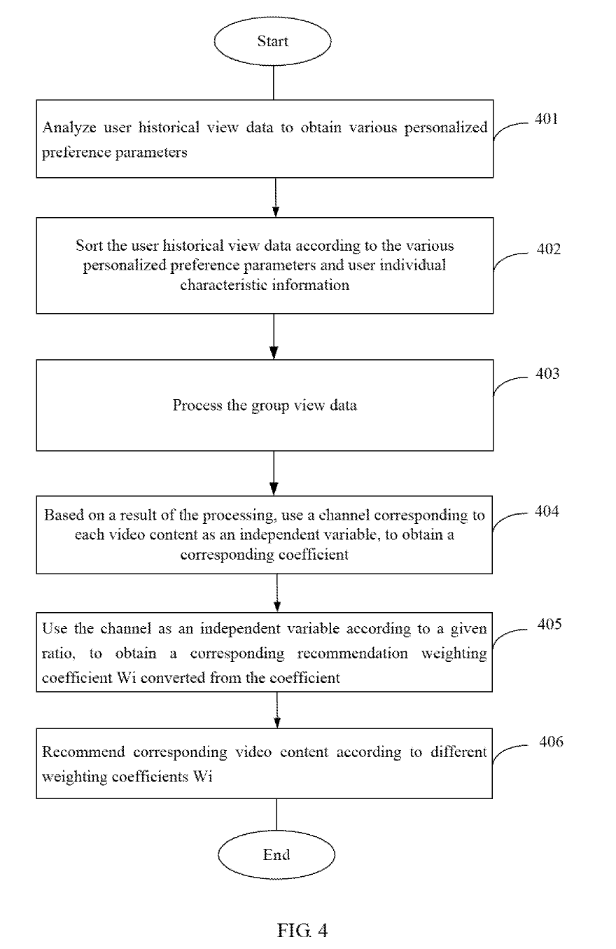

Another embodiment of the present disclosure further provides a method for video content recommendation, which is executed by a video content providing server (that is, the video content recommendation device). FIG. 4 is a schematic flow chart illustrating a method for video content recommendation according to another embodiment of the present disclosure.

In step 401: User historical view data is analyzed to obtain various personalized preference parameters.

For example, the video content providing server analyzes the user historical view data, to obtain a type of a video that the user prefers, and a distribution of time that the user prefers to spend on various types.

In step 402: The user historical view data is sorted and crossed according to the various personalized preference parameters and user individual characteristic information, to obtain group view data that is in accordance with the personalized preference parameters and the user individual characteristic information.

For example, the video content providing server sorts and crosses the user historical view data according to the obtained various personalized preference parameters in combination with the user individual characteristic information to obtain a corresponding group. For example, the user individual characteristic information includes data such as user age, income, and history of social platform activities, for example, a view time and a matching video type/matching video duration, key element data (such as actor/actress, language, and video stream version) preferred by users of different ages, incomes, or even education degrees.

In step 403: The group view data is processed according to an independent variable matrix that represents historical view data, an independent variable matrix that represents the user individual characteristic information, and a dependent variable matrix that represents the group vie data.

For example, the independent variable matrix that represents the historical view data, the independent variable matrix that represents the user individual characteristic information, and the dependent variable matrix that represents the group view data are put into the mixed effect model formula (1), and an operation is performed on the group view data according to the mixed effect model formula (1); for the mixed effect model formula (1), refer to the description above.

In step 404: A channel corresponding to each video content is used as an independent variable based on a result of the processing, to obtain a corresponding coefficient.

For example, based on an operation result of the mixed effect model formula (1), a channel corresponding to each video content is used as an independent variable to obtain a corresponding co-efficient, and the corresponding coefficient obtained by using the channel as an independent variable includes β and b ᵢ in the mixed effect model formula (1), where β represents a fixed effect, and bᵢ represents a random effect.

In step 405: The channel is used as an independent variable according to a given ratio, to obtain a corresponding recommendation weighting coefficient Wi converted from the coefficient.

The weighting coefficient Wi is a mathematical combination about β and bᵢ in Yᵢ=Xᵢβ+Zᵢbᵢ+εᵢ, and is synthesized through a series of computation methods, where a sum of all sequences of the weighting coefficient Wi is 100%.

In step 406: Corresponding video content is recommended according to different weighting coefficients Wi.

When the foregoing video content recommendation method is used, steps 402 to 405 are independent of each other in terms of operation details and formulation rules. Grouping that conforms to industry regulations is performed according to different user characteristics and content of content libraries. Finally, conversion is performed uniformly according to a self-defined mapping ride to obtain sequences of a weighting coefficient Wi, Where a sum of the sequences is 100%; and a video content combination is recommended in real time according to a sequence of the weighting coefficient Wi.

An embodiment the present disclosure provides a non-transitory computer-readable storage medium storing executable instructions that, when executed by an electronic device with a touch-sensitive display, cause the electronic device to:

analyze user historical view data to obtain various personalized preference parameters;

sort and cross the user historical view data according to the various personalized preference parameters and user individual characteristic information, to obtain group view data that is in accordance with the personalized preference parameters and the user individual characteristic information; and process the group view data according to an independent variable matrix that represents the historical view data, an independent variable matrix that represents the user individual characteristic information, and a dependent variable matrix that represents the group view data;

based on a result of the processing, use a channel corresponding to each video content as an independent variable, to obtain a corresponding coefficient;

use the channel as an independent variable according to a given ratio, to obtain a corresponding recommendation weighting coefficient Wi converted from the coefficient: and recommend corresponding video content according to different weighting coefficients Wi.

The computer readable storage medium includes any mechanism for storing or transferring information in a computer readable form (for example, a computer). For example, the computer readable medium includes a read-only memory (ROM), a random access memory (RAM), a disk storage medium, an optical storage medium, a flash storage medium, electricity, light, sound and other forms of propagation signals (for example, a carrier, an infrared signal, a digital signal and the like), and the like.

A person skilled in the art may clearly understand that, for the purpose of convenient and brief description, the foregoing division of functional modules is merely used as example for description, and in practical application, the foregoing functions may be allocated to and completed by different functional modules as required, that is, an internal structure of the apparatus is divided into different functional modules, to complete all or some of functions described above. For a specific working process of the system, apparatus, and unit described above, refer to the corresponding process in the aforementioned method embodiment, and details are not described herein again.

In several embodiments provided in the present disclosure, it should be understood that the disclosed system, apparatus and method may be implemented in Other manners. For example, the apparatus embodiment described above is merely exemplary For example, the division of modules or units is merely a logical function division, and in practical implementation, other division manners may be used, for example, multiple units or components may be combined or may be integrated into another system, or some features may be ignored or not executed. In addition, the displayed or discussed mutual couplings or direct couplings or communication connections may be implemented through some interfaces. The indirect couplings or communication connections between the apparatuses or units may be implemented in electronic, mechanical or other forms.

The apparatus embodiment described above is merely schematic. The units described as separate parts may or may not be physically separate, and the parts displayed as units may or may not be physical units, that is, they may be located in one position or may be distributed on a plurality of network units. Some of or all of the units may be selected according to actual needs to achieve the objectives of the solutions of the embodiments.

In addition, functional units in the embodiments of the present invention may be integrated into one processing unit, or each of the units may exist along physically, or two or more units may be integrated into one unit. The integrated units above may be implemented in a form of hardware or in a form of a software functional unit.

If the integrated units are implemented in a form of a software functional unit and sold or used as an independent product, the units may be stored in a computer readable storage medium. Based on such an understanding, the technical solutions of the present disclosure essentially, or the part contributing to the related art, or all or a part of the technical solutions may be implemented in a form of a software product. The computer software product is stored in a storage medium and includes several instructions to cause a computer device (which may be a personal computer, a server, a network device, or the like) or a processor to perform all or some of steps of the methods described in the embodiments of the present disclosure. The storage medium includes various media capable of storing program code, for example, a USB flash disk, a removable hard disk, a read-only memory (ROM), a random access memory (RAM), a magnetic disk, or an optical disc.

Finally, it should be noted that: the foregoing embodiments are merely used to illustrate the technical solutions of the present disclosure, but are not intended to limit the present disclosure. Although the present disclosure is described in detail with reference to the foregoing embodiments, a person of ordinary skill in the art should understand that they may still make modifications to the technical solutions described in the foregoing embodiments or make equivalent replacements to some technical features thereof, while such modifications or replacements do not cause the essence of the corresponding technical solution to depart from the spirit and scope of the technical solutions of the embodiments of the present disclosure.

What is claimed is:

1. A method for video content recommendation, comprising:
at an electronic device;
analyzing user historical view data to obtain various personalized preference parameters;
sorting and crossing the user historical view data according to the various personalized preference parameters and user individual characteristic information, to obtain group view data that is in accordance with the personalized preference parameters and the user individual characteristic information; and processing the group view data according to an independent variable matrix that represents the historical view data, an independent variable matrix that represents the user individual characteristic information, and a dependent variable matrix that represents the group view data;
based on a result of the processing, using a channel corresponding to each video content as an independent variable, to obtain a corresponding coefficient;
using the channel as an independent variable according to a given ratio, to obtain a corresponding recommendation weighting coefficient Wi converted from the coefficient; and
recommending corresponding video content according to different weighting coefficients Wi.

2. The method according to claim 1, wherein the processing the group view data according to an independent variable matrix that represents the historical view data, an independent variable matrix that represents the user individual characteristic information, and a dependent variable matrix that represents the group view data comprises:
putting the independent variable matrix that represents the historical view data, the independent variable matrix that represents the user individual characteristic information, and the dependent variable matrix that represents the group view data into a mixed effect model formula (1), and performing an operation on the group view data according to the mixed effect model formula (1);
wherein the mixed effect model formula (1) is:
Yᵢ32 Xᵢβ+Zᵢbᵢ+εᵢ
wherein β represents a fixed effect, bᵢ represents a random effect, and β and bᵢ and corresponding coefficients obtained by using the channel as an independent variable; Yᵢ represents a dependent variable matrix, and represents the group view data; Xᵢ represents an independent variable matrix, and represents the user individual characteristic information; represents a built-in error term matrix generated by the mixed effect model; Zᵢ represents another series of independent variable matrices whose attribute is different from that of Xᵢ, and represents the historical view data; Kᵢrepresents a weighting coefficient that meets Xᵢ=ZᵢKᵢ after a series settings in advance, and Xᵢ=ZᵢKᵢ is a known (nᵢ×p) covariance matrix; nᵢ represents the i^{th} sample among n samples; p represents a parameter reflected by an actual matrix operation stilt; i represents a sequence number i in the i^{th} sample, and is a positive integer: i=1, 2, 3, . . . , i.

3. The method according to claim 2, wherein the mixed effect model formula (1) further needs to satisfy the following requirements:
bᵢ˜N(0,D)
εᵢ˜N(0,Σᵢ)
cov(b₁,b₂, . . . , bᵢ;ε₁,ε₂, . . . ,ε_{N})=0
wherein bᵢ˜N(0,D) represents that b conforms to a standard normal distribution, and N (0, D) represents the standard normal distribution;
εᵢ˜N(0,Σᵢ) represents that cont rills to a standard normal distribution, εᵢ˜N(0,Σᵢ) represents the corresponding standard normal distribution, and Σᵢ represents a sum operation; and
cov(b₁,b₂, . . . , bᵢ;ε₁,ε₂, . . . ,ε_{N})=0 represents a covariance matrix, and coy represents a covariance.

4. The method according to claim 2, wherein a density equation of a dependent variable Yi is further used as a reference for a model result of the mixed effect model formula (1):
f(yᵢ)=∫f(yᵢ|bᵢ)f(bᵢ)dbᵢ
wherein f(yᵢ) represents an expression symbol of the density equation, yᵢ represents an element in the dependent variable Yi, f(yᵢ|bᵢ) represents a density equation of f (y) expressed with b, f(bᵢ) represents a density equation of b, and d represents a differential symbol.

5. The method according to any one of claims 1, wherein a sum of sequences of the weighting coefficient Wi is 100%.

6. An electronic device, comprising: at least one processor and a memory communicably connected with the at least one processor for storing, instructions executable by the at least one processor, wherein execution of the instructions by the at least one processor causes the at least one processor to:
analyze the user historical view data to obtain various personalized preference parameters; sort and cross the user historical view data according to the various personalized preference parameters and user individual characteristic information, to obtain group view data that is in accordance with the personalized preference parameters and the user individual characteristic information; process the group view data according to an independent variable matrix that represents the historical view data, an independent variable matrix that represents the user individual characteristic information, and a dependent variable matrix that represents the group view data; based on a result of the processing, use a channel corresponding to each video content as an independent variable, to obtain a corresponding coefficient; use the channel as an independent variable according to a given ratio, to obtain a corresponding recommendation weighting coefficient Wi converted from the coefficient; and determine corresponding recommended video content according to different weighting coefficients Wi; and the transmitter is configured to send the recommended video content.

7. The electronic device according to claim 6, wherein the instructions to process the group view data according to an independent variable matrix that represents the historical view data, an independent variable matrix that represents the user individual characteristic information, and a dependent variable matrix that represents the group view data cause the at least one processor to:
putting the independent variable matrix that represents the historical view data, the independent variable matrix that represents the user individual characteristic information, and the dependent variable matrix that represents the group view data into a mixed effect model formula (1), and performing an operation on the group view data according to the mixed effect model formula (1);
wherein the mixed effect model formula (1) is:
Yᵢ32 Xᵢβ+Zᵢbᵢ+εᵢ
wherein β represents a fixed effect, bᵢ represents a random effect, and β and bᵢ are corresponding coefficients obtained by using the channel as an independent variable; Yᵢ represents a dependent variable matrix, and represents the group view data; Xᵢ represents an independent variable matrix, and represents the user individual characteristic information; represents a built-in error term matrix generated by the mixed effect model; Zᵢ represents another series of independent variable matrices whose attribute is different from that of Xᵢ, and represents the historical view data; Kᵢrepresents a weighting, coefficient that meets Xᵢ=ZᵢKᵢ after a series of settings in advance, and Xᵢ=ZᵢKᵢ is a known (nᵢ×p) covariance matrix; nᵢ represents the ith sample among n samples; p represents a parameter reflected by an actual matrix operation result; i represents a sequence number i in the ith sample, and is a positive integer: i=1 2, 3, . . . , i.

8. The electronic device according to claim 7, wherein the at least one processor is further caused to perform the following operations according to the mixed effect model formula (1):
bᵢ˜N(0,D)
εᵢ˜N(0,Σᵢ)
cov(b₁,b₂, . . . , bᵢ;ε₁,ε₂, . . . ,ε_{N})=0
wherein bᵢ˜N(0,D) represents that b conforms to a standard normal distribution, and N (0, D) represents a standard normal distribution
εᵢ˜N(0,Σᵢ) represents that ε conforms to a standard normal distribution, εᵢ˜N(0,Σᵢ)represents the corresponding standard normal distribution, and Σᵢ represents a sum operation; and
cov(b₁,b₂, . . . , bᵢ;ε₁,ε₂, . . . ,ε_{N})=0 represents a covariance matrix, and coy represents a covariance.

9. The electronic device according to claim 7, wherein a density equation of a dependent variable Yi is further used as a reference for a model result of the operation performed by the at least one processor according to the mixed effect model formula (1):
f(yᵢ)=∫f(yᵢ|bᵢ)f(bᵢ)dbᵢ
wherein f(yᵢ) represents an expression symbol of the density equation, yᵢ represents an element in the dependent variable Yi, f(yᵢ|bᵢ) represents a density equation of f(y) expressed with b, f(bᵢ) represents a density equation of b, and d represents a differential symbol.

10. A non-transitory computer-readable storage medium storing executable instructions that, when executed by an electronic device with a touch-sensitive display, cause the electronic device to:
analyze user historical view data to obtain various personalized preference parameters;
sort and cross the user historical view data according to the various personalized preference parameters and user individual characteristic information, to obtain group view data that is in accordance with the personalized preference parameters and the user individual characteristic information; and process the group view data according to an independent variable matrix that represents the historical view data, an independent variable matrix that represents the user individual characteristic information, and a dependent variable matrix that represents the group view data;
based on a result of the processing, use a channel corresponding to each video content as an independent variable, to obtain a corresponding coefficient;
use the channel as an independent variable according to a given ratio, to obtain a corresponding recommendation weighting coefficient Wi converted from the coefficient; and recommend corresponding video content according to different weighting coefficients Wi.
